(19) United States
(12) Patent Application Publication
(10) Pub. No.: US 2005/0233719 A1
(43) Pub. Date: Oct. 20, 2005

(54) Apparatus and method for improved performance in a digital radio

(76) Inventor: Robert G. DeMoor, Sugar Land, TX (US)

Correspondence Address: TEXAS INSTRUMENTS INCORPORATED, P O BOX 655474, M/S 3999, DALLAS, TX, 75265, US

(21) Appl. No.: 10/828,052

(22) Filed: Apr. 20, 2004

(51) Int. Cl. H04B 1/10

(52) U.S. Cl. 455/221

(57) ABSTRACT

In order to accommodate increased processing requirements as additional functionality is added to the digital radio, an audio postprocessor unit is coupled to the output of the demodulation/processing unit. In this manner, the processing capability of the digital radio can be enhanced with relatively minor changes in the hardware and software.

### 1. FIELD OF THE INVENTION

This invention relates generally to digital radios and, more particularly, to performance enhancement of the digital radio in response to increasing functionality.

### 2. BACKGROUND OF THE INVENTION

At the present time, digital radio systems employ a multiplicity of formats for broadcast band transmission. The common factor of the digital radio broadcast band is the inclusion of at least one digitally modulated-channel in the transmitted broadcast band. Because the broadcast band transmission can include both digital- and analog-encoded signals, the digital radio can be required to demodulate and decode both types of modulated signals simultaneously.

Referring to FIG. 1, a block diagram of a digital radio 10, according to the prior art, is shown. The digital radio 10 includes an antenna unit 5. The antenna unit can be a part of the digital radio 10 or can be coupled to the digital radio by a conducting element. The signals picked up by the antenna 5 are applied to the receiver unit/down-converter unit 101. The output signals of the receiver unit/down-converter unit 101 are modulated signals having an intermediate frequency. The receiver unit/down-converter unit 101 applies the intermediate frequency signals to analog-to-digital converter unit 102. The analog-to-digital converter 102 converts the digitally-encoded signal carriers and the analog-encoded signal carriers to digital serial data. The output signals from the analog-to-digital converter are applied to the demodulator unit/processor unit 103. The demodulator unit/processor unit 103 demodulates and decodes both the analog and digital transmitted signal content. The analog and digital signal channel signals are applied to the demodulator unit/processing unit 103 together, but are demodulated and processed separately in the unit 103. The demodulator unit/processing unit 103 exchanges program and data signals with the memory unit 104. The processing unit 103, in response to a user input and the program stored in memory unit 104, processes the signals received from the analog-to-digital converter unit 102. For example, a decompression algorithm can be applied to the received signals. The processed signals from the demodulator unit/processing unit 103 are applied to digital to analog converter unit 105. The output signals from are applied through amplifying units 109 through 110 to speaker unit 107 through 108, respectively.

In addition to the already computation-intensive demodulation and processing unit of the digital radio, increased functionality is being added to the digital radio. Even without the increased functionality requirement, the processing capabilities are close to being fully utilized. The Texas Instruments digital signal processor (DSP) using a C64X core can operate at 500 MHz (millions of clock cycles per second). In automotive applications, the processor must furthermore operate in a large ambient temperature range that compromises the DSP performance. Substantially all of this processing capability is used in routine demodulation/processing of the broadcast band, for example in implementing the fast Fourier transform and other computationally-intense algorithms. If audio processing applications, such as equalization, are included in the digital radio, an additional 50 MHz can be required. Similarly, when the digital radio is required to process MP3 files, an additional 50 MHz is required. As will be clear, as further functionality, such as automotive dual zone audio (i.e., dual zone meaning that some passengers can listen to one program while other passengers can listen to a second program) becomes common, additional performance is required.

A need has therefore been felt for apparatus and an associated method having the feature that processing capability of a digital radio can be increased. It would be another feature of the apparatus and associated method to provide increased performance in a digital radio without designing a new processor. It would be yet another feature of the present invention to provide increased performance in a digital radio while retaining the software that has already been developed for the demodulation/processing unit.

### SUMMARY OF THE INVENTION

The aforementioned and other features are accomplished, according to the present invention, by providing in the digital radio an audio postprocessor coupled to the output of the demodulation/processing unit. The audio postprocessor permits the demodulation/processing unit to off-load selected repetitious procedures used in processing the audio signal stream. The use of an audio postprocessor in the digital radio allows much of the software already developed to be retained, selected portions of the processing being transferred to the audio postprocessor.

Other features and advantages of the present invention will be more clearly understood upon reading of the following description and the accompanying drawings and claims.

### BRIEF DESCRIPTION OF THE DRAWINGS

FIG. 1 is a block diagram illustrating the principal components of a digital radio according to the prior art.

FIG. 2 is a block diagram illustrating the principal components of a digital radio according to the present invention.

### DESCRIPTION OF THE PREFERRED EMBODIMENT

1. Detailed Description of the Drawings

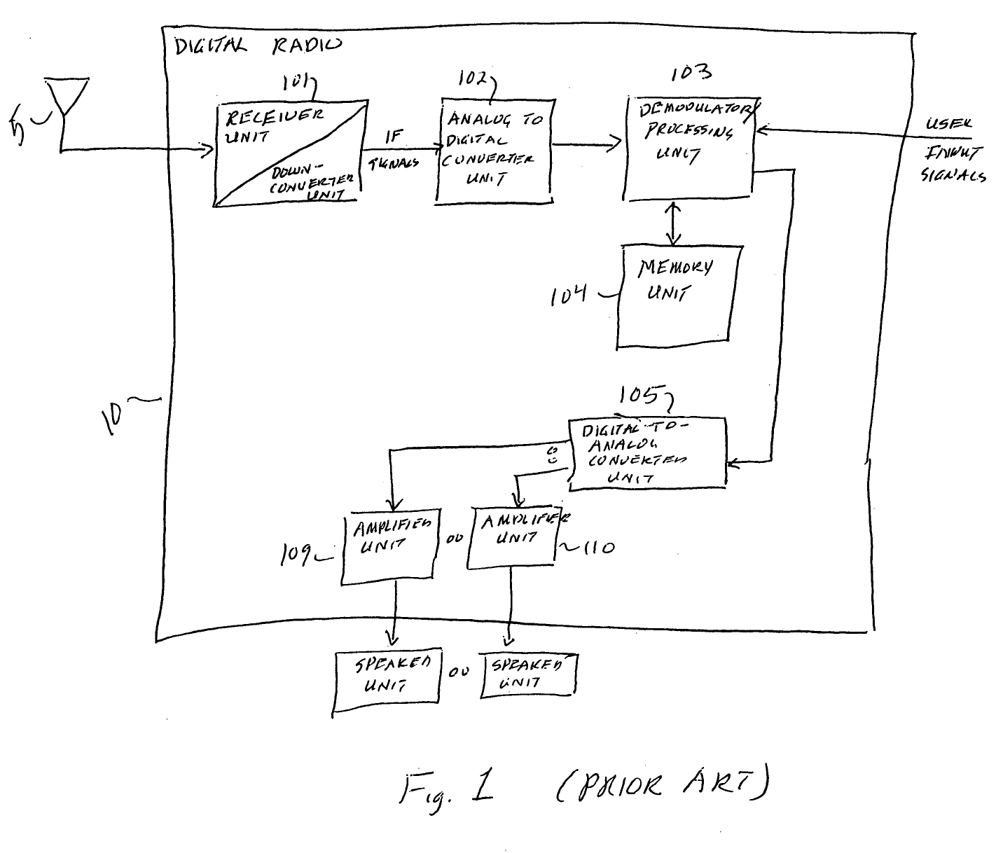

FIG. 1 has been described with reference to the related art.

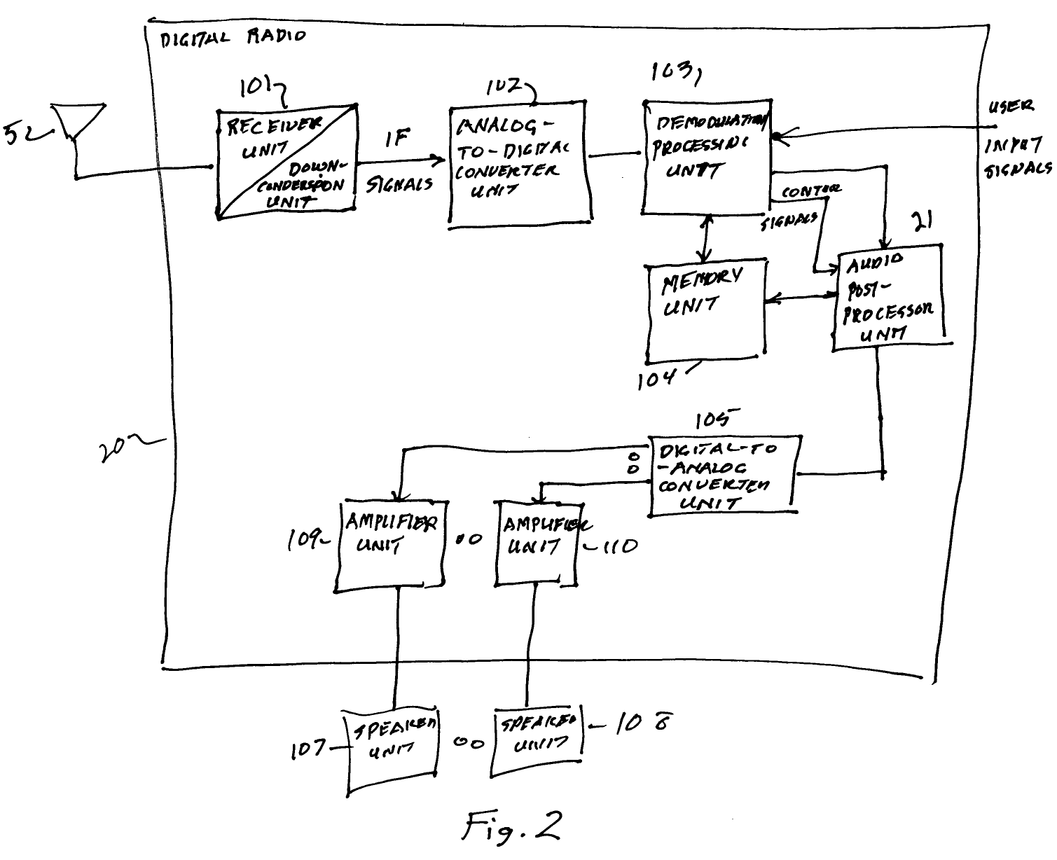

Referring to FIG. 2, a block diagram of the digital radio 20 according to the present invention is shown. As will be clear by comparing FIG. 1 to FIG. 2, the difference between the two block diagrams is that the output signals from demodulation/processor unit 103 (i.e., the reconstructed audio signals of the broadcast band) are applied through and audio postprocessor unit 21 to the digital to analog converter unit 105. The audio postprocessor unit 21 is operated under control of the demodulation/processor unit 103 and receives software procedures (e.g., stored in the memory unit 104). The procedures executed by the audio postprocessor unit 21 prepare the transmitted audio signal groups for application to speaker systems in a format determined by the user input signals. For example, the intensity of regions of the frequency spectrum of the reconstructed audio signal group can selectively enhanced or attenuated depending on the audio genre being processed by the digital radio.

Operation of the Preferred Embodiment

The present invention provides for the inclusion in a digital radio of audio postprocessor unit to assist in processing. The postprocessor unit permits the demodulation/processing unit of the digital radio to off-load hardware-intensive processing (e.g., such as equalization) of the audio signal reconstructed from transmitted by the broadcast band. By using the postprocessor unit 21, much of the original software can be utilized. As will be clear from FIG. 2, much of the original architecture remains intact with the only change being the addition of the postprocessor unit 21. Audio (post)processors have already been designed and tested and the integration of these processors in a digital radio is relatively simple.

While the invention has been described with respect to the embodiments set forth above, the invention is not necessarily limited to these embodiments. Accordingly, other embodiment variations, and improvements not described herein, are not necessarily excluded from the scope of the invention, the scope of the invention being defined by the following claims.

1. A digital radio comprising:
a receiver/down converter unit for providing intermediate frequency signals;
an analog-to-digital converter unit converting the intermediate frequency signals to digitized signals;
a demodulator/processing unit demodulating and processing the digitized signals;
an audio postprocessor unit coupled to the demodulator/processing unit;
a digital-to-analog converter unit responsive to the signals from the postprocessor unit for providing analog output signals; and
at least one speaker unit for providing an audio output in response to the analog output signals.

2. The digital radio as recited in claim 1 wherein the postprocessor processes reconstructed audio signal streams.

3. The digital radio as recited in claim 1 using software required in a digital radio without the inclusion of the postprocessor.

4. The digital radio as recited in claim 1 wherein the postprocessor unit and the demodulation/processing unit process data streams in response to user input signals.

5. The digital radio as recited in claim 1 further including a memory unit storing software procedures.

6. The digital radio as recited in claim 1 wherein the postprocessor unit is an audio postprocessor unit.

7. The method of processing digitized signals in a digital radio, the method comprising:
coupling an audio postprocessor to a modulation/processing unit; and
transferring an audio stream to the audio postprocessor.

8. The method as recited in claim 7 further comprising executing the selected audio processing procedures simultaneously with procedures being executed in the demodulation/processing unit

9. The method as recited in claim 7 further comprising storing the selected procedures in a memory unit coupled to the demodulation/processing unit and to the audio postprocessor unit.

10. The method as recited in claim 7 wherein the demodulation/processing unit processes at least one digitally-modulated channel.

11. The method as recited in claim 7 wherein the audio postprocessor processes the reconstructed audio signals from the broadcast band.

12. A digital radio comprising:
a demodulation/processing unit demodulating and processing at least one digitally-modulated channel; and
a postprocessor unit coupled to the demodulation/processing unit, the postprocessor unit processing audio signals from the demodulation/processing unit.

13. The digital radio as recited in claim 12 wherein the audio signals are the reconstructed audio signals from the broadcast band.

14. The digital radio as recited in claim 12 wherein the postprocessor unit is an audio postprocessor unit.
